(19) United States
(12) Patent Application Publication
(10) Pub. No.: US 2026/0368603 A1
(43) Pub. Date: Nov. 19, 2026

(54) DEVICE FOR EVALUATING AND MITIGATING NOISE IN A QUANTUM COMPUTER AND CONTROL METHOD THEREOF

(71) Applicant: LG ELECTRONICS INC., Seoul (KR)

(72) Inventors: Gaurav SAXENA, Toronto (CA); Thi Ha KYAW, Burlington (CA); Ahmed SHALABI, Waterloo (CA)

(73) Assignee: LG ELECTRONICS INC., Seoul (KR)

(21) Appl. No.: 18/642,468

(22) Filed: Apr. 22, 2024

Related U.S. Application Data
(60) Provisional application No. 63/460,933, filed on Apr. 21, 2023.

(51) Int. Cl. G06N 10/70; G06N 10/20; G06N 10/60

(52) U.S. Cl. CPC G06N 10/70; G06N 10/20; G06N 10/60

(57) ABSTRACT

A method for controlling a quantum computing device can include inputting input parameters to a quantum processor, running a quantum circuit based on the input parameters to generate first element values for a state evolution matrix and second element values for a Hamiltonian based vector, performing, via a transistor based processor, an error mitigation operation by dividing the state evolution matrix based on a first mitigation component to generate a compensated state evolution matrix and dividing the Hamiltonian based vector based on a second mitigation component to generate a compensated Hamiltonian based vector, and solving a cost function based on the compensated state evolution matrix and the compensated Hamiltonian based vector to generate updated parameters. Also, the method can further include in response to reaching convergence, outputting a final result, and in response to nonconvergence, inputting the updated parameters to the quantum processor and running the quantum circuit again.

### CROSS-REFERENCE TO RELATED APPLICATIONS

This non-provisional application claims priority under 35 U.S.C. § 119(e) to U.S. Provisional Application No. 63/460,933, filed on Apr. 21, 2023, the entirety of which is hereby expressly incorporated by reference into the present application.

### BACKGROUND

### Field

The present disclosure relates to a device and method for evaluating and mitigating noise in a quantum computer. Particularly, the method can address errors incurred in running quantum imaginary time evolution (QITE) algorithms on quantum hardware, in the field of quantum computing and artificial intelligence (AI).

### Discussion of the Related Art

Quantum computers represent a revolutionary leap forward in computing technology with their potential to solve complex problems exponentially faster than classical computers.

Unlike classical computers that use transistors to implement binary bits, which can be either 0 or 1, quantum computers use qubits. Qubits can exist in a superposition of states, allowing them to perform multiple calculations simultaneously and potentially tackle problems that are intractable by classical computers.

For example, quantum computers promise a quantum advantage in numerous applications, such as factoring, solving linear systems, quantum simulations, and quantum chemistry/material discovery.

However, the power of quantum computers comes with unique challenges, such as dealing with noise and decoherence. Quantum systems are inherently fragile and susceptible to various sources of noise and errors. These errors can arise from interactions with the environment, imperfections in hardware components, or limitations in control and measurement mechanisms.

Particularly, hybrid quantum computers which implement an architecture of a classical computer and a quantum computer working together to solve a problem, also referred to as noisy intermediate scale quantum (NISQ) computers, can execute algorithms that are often designed for short-depth quantum circuits having limited numbers of qubits and gates, e.g., variational quantum algorithms (VQAs).

However, even NISQ computers having short-depth quantum circuits are not fault tolerant, and the presence of noise and errors can limit their utility. For example, the result output by a quantum computer may be so influenced by noise and errors that its output becomes unreliable or unusable.

Also, a considerable amount of time and resources may end up be wasted in designing, setting up and running a quantum computer that turns out to be so noisy and susceptible to errors that its output is not useful. Instead, these resources could have been put to better use for other quantum circuit designs, particularly ones that are likely to be more tolerant to noise.

Thus, there exists a need for being able to evaluate how well an algorithm will perform given a particular quantum circuit and a number of parameters.

Also, a need exists for determining the bounds on errors in running the quantum imaginary time evolution (QITE) algorithm on real quantum hardware, and generalizing how the algorithm works when noise is factored into its performance.

In addition, there exists a need for the ability to determine whether the dominate noise in the quantum system is depolarizing noise.

Also a need exists for an ability to perform noise mitigation to reduce the effect of such noise, in order to produce more accurate and reliable results. Further, a need exists for an elegant noise mitigation technique that can reduce processing time and conserve resources.

### SUMMARY OF THE DISCLOSURE

The present disclosure has been made in view of the above problems and it is an object of the present disclosure to provide a device and method that can evaluate and mitigate noisy quantum data in a quantum computer. Further, the method can address errors incurred in running quantum imaginary time evolution (QITE) algorithms on quantum hardware, in the field of quantum computing and artificial intelligence (AI).

An object of the present disclosure is to provide a method for controlling a quantum computing device that includes inputting input parameters to a quantum processor, the quantum processor including a plurality of qubits, running, via the quantum processor, a quantum circuit based on the input parameters to generate first element values for a state evolution matrix and second element values for a Hamiltonian based vector, the quantum circuit including a plurality of quantum gates, performing, via a processor that is transistor based, an error mitigation operation by dividing the state evolution matrix based on a first mitigation component to generate a compensated state evolution matrix and dividing the Hamiltonian based vector based on a second mitigation component to generate a compensated Hamiltonian based vector, solving a cost function based on the compensated state evolution matrix and the compensated Hamiltonian based vector, via the processor, to generate updated parameters, in response to reaching a state of convergence, outputting, via the processor, a final result, and in response to convergence not being reached, inputting the updated parameters to the quantum processor and running the quantum circuit again based on the updated parameters.

It is another object of the present disclosure to provide a method for controlling a quantum computing device, in which the quantum circuit is based on a quantum imaginary time evolution (QITE) algorithm.

Another object of the present disclosure is to provide a method, in which the dividing the state evolution matrix includes dividing each of the first elements by the first mitigation component, and the dividing the Hamiltonian based vector includes dividing each of the second elements by the second mitigation component.

An object of the present disclosure is to provide a method, in which the input parameters include a probability value corresponding to a probability of mixing white noise, the first mitigation component is defined by a first equation: (1−p)2N, and the second mitigation component is defined by a second equation: (1−p)N, where p is the probability value, and N is a number of parameters of the quantum circuit.

Another object of the present disclosure is to provide a method that includes running, via the quantum processor, the quantum circuit for a first number of times to generate the state evolution matrix, and running, via the quantum processor, the quantum circuit for a second number of times to generate the Hamiltonian based vector, in which the first number of times is less than the second number of times.

Yet another object of the present disclosure is to provide a method, in which the first number of times is (d(d−1))/2, and the second number of times is d, where d is a dimension of the state evolution matrix.

An object of the present disclosure is to provide a method, in which the cost function is based on solving for θ′ in equation:

$${\sum }_{q} {M}_{k , q} {\dot{θ}}_{q} = {Y}_{k} ,$$

where M is the state evolution matrix, θ′ is a vector including elements each corresponding to a change of a parameter for a given time step, and Y is the Hamiltonian based vector, and k and q are indexing values.

Another object of the present disclosure is to provide a method, in which the error mitigation operation mitigates errors due to a depolarizing quantum noise channel.

An object of the present disclosure is to provide a method, in which the updated parameters include rotation angle values for adjusting the plurality of quantum gates in the quantum circuit.

Another object of the present disclosure is to provide a method that further includes determining a ground state of the quantum circuit based on the final result.

An object of the present disclosure is to provide a quantum computing device that includes a memory configured to store parameter information, a quantum processor including a plurality of qubits, configured to receive input parameters, run a quantum circuit based on the input parameters to generate first element values for a state evolution matrix and second element values for a Hamiltonian based vector, the quantum circuit including a plurality of quantum gates, and output the state evolution matrix and the Hamiltonian based vector, and a processor that is transistor based, configured to receive the state evolution matrix and the Hamiltonian based vector from the quantum processor, perform an error mitigation operation by dividing the state evolution matrix based on a first mitigation component to generate a compensated state evolution matrix and dividing the Hamiltonian based vector based on a second mitigation component to generate a compensated Hamiltonian based vector, solve a cost function based on the compensated state evolution matrix and the compensated Hamiltonian based vector to generate updated parameters, in response to reaching a state of convergence, output a final result, and in response to convergence not being reached, input the updated parameters to the quantum processor for running the quantum circuit again based on the updated parameters.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates a hybrid quantum-classical computer architecture according to an embodiment of the present disclosure.

FIG. 4 illustrates an example of a variation quantum circuit according to an embodiment of the present disclosure.

FIG. 5 illustrates a plot of the upper bound on the relative error regarding depolarizing noise.

FIG. 6 shows an example flow chart for a method implementing a quantum imaginary time evolution algorithm, according to an embodiment of the present invention.

FIG. 7 illustrates an example flow chart for a method of controlling a quantum computing device, according to an embodiment of the present invention.

FIG. 8 illustrates an example flow chart for a method implementing a quantum imaginary time evolution algorithm with noise mitigation, according to an embodiment of the present invention.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Also, the term device used herein can refer to a single device or a group of multiple devices that are connected together via wired connections or wireless connections.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Quantum computing is a field of computing that that utilizes the principles of quantum mechanics to process and store information. At its core are quantum bits, or qubits, which can exist in multiple states simultaneously due to superposition. Unlike classical bits, which are either 0 or 1, qubits can represent 0, 1, or any combination of both at the same time. This property allows quantum computers to perform many calculations simultaneously, potentially solving complex problems exponentially faster than classical computers.

Also, quantum computing can take advantage of any two state system, e.g., qubits can be based on the spin of an electron, photon polarization, superconducting circuits, nuclear spin, trapped ions, defects in diamond crystals, etc. Quantum computing also involves entanglement, where the states of qubits are interconnected and offer powerful computation capabilities (e.g., computations can scale exponentially by 2n where n is the number of qubits).

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

In addition, a hybrid quantum-classical computer architecture can incorporate a neural network by combining the strengths of both classical and quantum computers to solve complex problems. The quantum component of the architecture can include qubits, which are employed to execute specific quantum computations suited for tasks like quantum simulations, optimization, or solving quantum chemistry problems (e.g., a QPU). Also, the classical part of the architecture can include one or more CPU's that can handle tasks that are not well suited for quantum processing, such as managing the overall computation, handling input and output, and running classical algorithms. Further, a neural network can be used to translate data and tasks between the CPU and the QPU, and for optimizing the system, solving for parameters and adjusting parameters (e.g., minimizing a cost function).

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

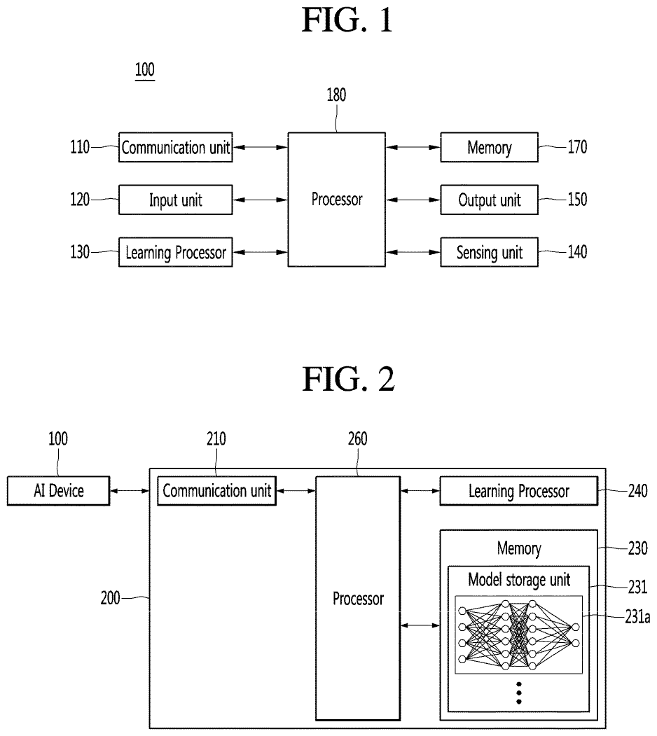

FIG. 1 illustrates an artificial intelligence (AI) device 100 which can be used as part of a hybrid quantum-classical computer architecture (e.g., the classical part), according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

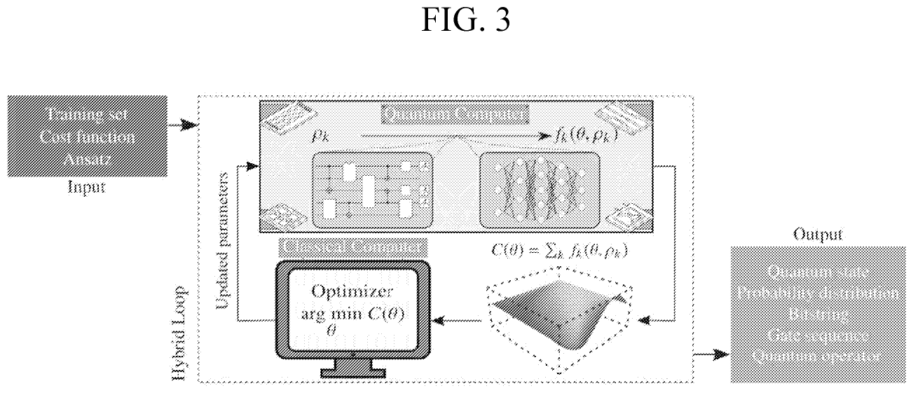

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a data analysis algorithm or a machine learning algorithm. The processor 180 can control the components of the AI device 100 to execute the determined operation. For example, the processor 180 can evaluate logic rules for solving for or finding parameters that are fed into a quantum circuit (e.g., rotation angles for quantum gates, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information for the user input and can determine an answer or a recommended item or action based on the acquired intention information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment. The AI sever can implement one or more components or tasks related to the classical computing portion in the hybrid quantum-classical computer architecture.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in the memory 230.

The processor 260 can infer the result value for new input data by using the learning model and can generate a response or a control command based on the inferred result value.

FIG. 3 illustrates a hybrid quantum-classical computer architecture according to an embodiment of the present disclosure.

The hybrid quantum-classical computer architecture can include a Quantum Processing Unit (QPU) and a Classical Processing Unit (CPU) interfaced to leverage the advantages of quantum and classical computing. The QPU includes qubits capable of superposition and entanglement for executing quantum algorithms and operations to tackle complex problems with exponential speed-ups. For example, the qubits can represent multiple states simultaneously due to superposition, enabling various quantum algorithms and quantum simulations.

In addition, the CPU can manage classical computations, data input/output, and overall system control. An interface layer can be included which facilitates communication between the quantum and classical components, such as translating high-level tasks into quantum operations and vice versa. This layer includes software, firmware, and protocols for carrying out tasks, optimizing performance, and managing the hybrid system.

Quantum algorithms are run on the QPU to exploit quantum properties such as superposition and entanglement. These algorithms, such as variational quantum algorithms (VQA) and quantum chemistry simulations, can outperform classical counterparts in specific tasks. Also, control software operating on the CPU can oversee the hybrid system's operation, including error correction, noise mitigation, and optimization routines used for quantum computation.

In addition, error correction and mitigation techniques can be integrated into the architecture to address inherent noise and error rates in the quantum hardware. The hybrid architecture can also include an application layer for user interface software and algorithms, enabling interaction with the system for inputting problems, receiving results, and analyzing data.

In more detail, the classical computer can include an optimizer or optimization function, which can implement a cost function or objection function. The cost function can be optimized using various techniques, such as gradient descent, but embodiments are not limited thereto. Also, the optimizer can use various hyperparameters, such as determining how many iterations to use and how big the steps should be for use in a descent for converging on a minimum.

The hybrid quantum-classical computer architecture can be referred to as a noisy intermediate scale quantum (NISQ) computer or a NISQ device.

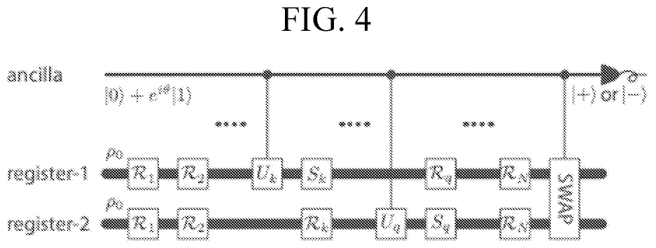

FIG. 4 shows an example of a variational quantum circuit that can be implemented by the QPU. The variational quantum circuit can include multiple qubits, such as a first qubit for register-1, a second qubit for register-2, and an ancilla qubit. The quantum circuit in FIG. 4 is an example of a short-dept quantum circuit. For example, NISQ algorithms can be designed for short-depth quantum circuits with limited numbers of qubits and gates, e.g., variational quantum algorithms (VQAs).

Also, optimization problems often arise in physics, mathematics, and computer science. The problem of finding the ground state pertaining to a Hamiltonian is one such problem which can be cast as an optimization problem. Variational quantum algorithms (VQAs) can be utilized to address this problem. VQAs can use noisy quantum computers and classical optimization to solve such optimization problems and can gain near term quantum advantage.

A significant family of VQA algorithms is the quantum imaginary time evolution (QITE), which can be used in various applications such as efficiently finding the ground state of a Hamiltonian, diffusion quantum Monte Carlo, etc.

For example, according to an embodiment, the NISQ computer can implement a quantum imaginary time evolution (QITE) based algorithm to find the lowest energy state in a quantum system. Initially, a starting guess (e.g., an ansatz) can be used to try and determine the ground state encoded in a quantum circuit. The quantum circuit can apply specific quantum gates to manipulate qubits in the quantum computer, which represent the system.

In addition, instead of using regular time, “imaginary time” can be used, in which the quantum computer executes the circuit by simulating the system's evolution in imaginary time. Trotterization techniques can be used to decompose the exponential term (−iHτ) to break down the evolution into smaller, more manageable operations applied to quantum gates (e.g., Trotter-Suzuki decomposition), but embodiments are not limited thereto.

Further, at each time step, these simplified operations can be applied to the qubits in the quantum computer. For example, the operations can include rotations around certain axes, e.g., RY gates for qubit rotations, etc.

After completion a certain imaginary time step (τ), measurements can be performed on the qubits. These measurements can provide information about the current state's proximity to the ground state. For example, the measured information can be used to determine how well the system is evolving towards the desired state.

In addition, based on the measurements and a given cost function, the classical computer can solve for various parameters and apply the updates to the quantum gates to improve the evolution. In other words, the guess for finding the ground state (e.g., lowest energy state) can be effectively refined.

Then, many small time steps can be iterated through while further adjusting the parameters at each step to minimize the energy of the system. This can be repeated as a type of optimization loop and the system should gradually converge to the ground state.

As a result, the QITE algorithm can find a quantum state that represents a reliable approximation of to the ground state of the system. This state corresponds to the lowest possible energy configuration of the quantum system under the given Hamiltonian.

In other words, the QITE algorithm can evolve a quantum system in imaginary time, using gate operations, measurements, and optimization to find the ground state of the system. However, the quantum computer is sensitive to noise, which may lead to inaccurate results or convergence may get stuck in a local minima rather than finding the true ground state.

In more detail, QITE works by propagating quantum data to evolve a quantum state. In general, imaginary time evolution or a Wick rotation is a simple but powerful mathematical technique that involves mapping to the time coordinate τ=it. While simulating imaginary time evolution can be done by a classic computer, the resources required scale exponentially with the size of the Hilbert space in question. Also, performing quantum imaginary time evolution involves non-unitary evolution and thus, implementing it using digital quantum computers is hard as quantum processors only allow for unitary operations via quantum gates.

According to an embodiment, a hybrid quantum-classical variational approach can be used to implement the quantum imaginary time evolution. Imaginary time evolution of the Wick-rotated Schrödinger equation can be implemented by encoding an initial quantum state as a parameterized quantum state |φ(τ))≈|φ(θ(τ))> where θ is a real valued parameter vector θ(τ)=(θ1(τ), θ2(τ), . . . , θN(τ)). To simulate non-unitary dynamics, an approximate formulation of imaginary time evolution derived from a generalized McLachlan's variational principle can be used to evolve the parameterized variational circuit.

A later step of the quantum imaginary time evolution algorithm involves solving a linear equation, as shown below in Equation 1.

Mθ′=Y [Equation 1]

The solution θ′ then dictates the evolution of variational parameters of the ansatz circuit for the next time step: θ(τ+Δτ)≈θ(τ)+θ′×Δτ. The matrix M and the vector Y depend on the ansatz circuit and the given Hamiltonian. According to another embodiment, for the real-time evolution, a similar type of equation can be used, but Y is replaced by a different vector V and the equation becomes M θ′=V.

In addition, the QITE algorithm operates by encoding the solution to a problem to a vector θ where each iteration of the algorithm as shown in FIG. 3 should move closer to the solution. This is done by solving the following equation 2, below.

$${\sum }_{q} {M}_{k , q} {\dot{θ}}_{q} = {Y}_{k} \qquad [ Equation 2 ]$$

According to an embodiment, equation 2 can then be solved by the classical computer. The M matrix and Y vector are obtained from quantum circuit evaluations. When quantum circuits are noisy, the resulting M and Y will be different from the true ones.

Since the solution of the linear equation is highly dependent on the inverse of M which is very sensitive to tiny changes in its matrix elements, it is desirable to have quantitative measures on how much noise a quantum circuit can have before solutions given by the QITE algorithm are rendered meaningless.

Thus, it is desirable to be able to evaluate how well such algorithms will perform on real quantum hardware, which can be noisy. For instance, given the noisy nature of quantum processors, it is desirable to understand how well the quantum imaginary (real) time evolution algorithm performs in absence of any error correction or mitigation technique.

In particular, it is desirable to know the impact of hardware errors incurred during each iteration on the exact rate of change of parameters, θ′ used to estimate the next set of variational parameters θ(τ+Δτ).

According to an embodiment, a method is provided that can determine the upper bounds on the error incurred in solving Equation 2.

In particular, environmental noise can be seen as a non-unitary evolution in addition to the unitary gates that are implemented in any quantum circuit (e.g., such as in FIG. 4).

According to an embodiment, a depolarizing quantum noise channel can be represented by Equation 3, below.

$$ℰ ( ρ ) = p \frac{I}{d} + ( 1 - p ) ρ \qquad [ Equation 3 ]$$

In Equation 3, ε represents the error due to the noise, ρ represents the quantum state or density matrix of the qubit(s), p represents the probability of the error occurring in the quantum circuit, I represents the identity matrix (e.g., which can be the same dimension as ρ), and d represents the dimension of the system (e.g., 2n where n is the number of qubits). Further, the matrix I/d is a quantum state known as the maximally mixed state and does not contain any information.

In addition, using Equation 3 above, the noise can be trace operation (Tr) and the effect of a noisy quantum circuit after going through a number of steps N can be shown as Equation 4, below.

$$Tr [ ( \text{?} {ρ}_{0} \text{?} ( \text{?} {ρ}_{0} ) ] = ( {p ( 1 - p )}^{k - 1} ( a + bp + … + {cp}^{N - k} ) Tr [ \text{?} ] ) ( \frac{1}{d} p ( 1 - \text{?} ( \text{?} + fp + … + \text{?} ) Tr [ {P}_{q} \text{?} ] + \frac{{( 1 - p )}^{N}}{d} Tr [ {P}_{q} \text{?} ] ) + {( 1 - p )}^{N - k + 1} ( 1 - {( 1 - p )}^{k - 1} ) ( \frac{{( 1 - p )}^{N - q + 1} ( 1 - {( 1 - p )}^{q - 1} )}{{d}^{2}} Tr [ {ℛ}_{N} … \text{?} ( {P}_{k} ) {ℛ}_{N} … \text{?} ( {P}_{q} ) ] + \frac{{( 1 - p )}^{N}}{d} Tr [ {ℛ}_{N} ∘ … ∘ {ℛ}_{k + 1} ( {P}_{k} ) {ℛ}_{N} ∘ … ∘ {ℛ}_{q + 1} ( \text{?} {ρ}_{q - 1} \text{?} ) ] ) + {( 1 - p )}^{N} ( \frac{p}{d} ( 1 - p \text{?} ( \text{?} + fp + … + \text{?} ) Tr [ {P}_{q} {ρ}_{q - 1} ] Tr ( {P}_{k} {ρ}_{k - 1} ) + \frac{( 1 - p \text{?} ( 1 - ( 1 - p \text{?}}{d} Tr [ {R}_{N} ∘ … ∘ {R}_{k + 1} ( \text{?} ) {R}_{N} ∘ … ∘ \text{?} ( {P}_{q} ) ] + {( 1 - p )}^{N} Tr [ {R}_{N} ∘ … ∘ \text{?} ( \text{?} ) {R}_{N} ∘ … ∘ {R}_{q + 1} ( \text{?} ) ] ) . \qquad [ Equation 4 ]$$

$$\text{?} \text{indicates text missing or illegible when filed}$$

Equation 4 above can be viewed as a type of intermediate step, which can be used for finding the elements of the M matrix and the Y vector for the situation when the noise is present in quantum systems. When the noise in the system is coming from the depolarizing channel, the elements of the matrices M and Y are as shown in Equations 5, 6 and 7, below.

$${M}_{k , k}^{err} = {( 1 - p )}^{2 N} ( \frac{1}{2} - \frac{1}{2} {Tr [ {P}_{k} {ρ}_{k - 1} ]}^{2} ) \qquad [ Equation 5 ]$$

$${M}_{k , q}^{err} = {( 1 - p )}^{2 N} ( \frac{1}{4} Tr [ {ℛ}_{q} … {ℛ}_{k + 1} ( {P}_{k} ) ( {ρ}_{q} {P}_{q} - 2 {ρ}_{q} {P}_{q} {ρ}_{q} + {P}_{q} {ρ}_{q} ) ] ) \qquad [ Equation 6 ]$$

$${Y}_{k}^{err} = {( 1 - p )}^{N} ( \frac{i}{2} Tr [ ( {ℛ}_{N} … {ℛ}_{k + 1} ( {ρ}_{k} {P}_{k} - {P}_{k} {ρ}_{k} ) ) ( ρ H + H ρ ) ] ) \qquad [ Equation 7 ]$$

The elements of the matrix M with noise error can be expressed according to Equation 6. Equation 5 is simplified because it represents the diagonal. Also, the elements of vector Y with noise error can be expressed as Equation 7.

Further, as shown above, the relative error is upper bounded by a function of p (e.g., the probability which gets the maximally mixed state), N (e.g., the number of parameters in the quantum circuit), and the condition number of M.

In addition, based on the equations above, the upper bound for the error due to general noise experienced in the quantum system can be expressed by equation 8, below.

$$\frac{ϵ}{‖ \dot{θ} ‖} \leq cond ( M ) ( ( 1 - {( 1 - p )}^{2 N} ) ( 1 + \frac{N}{2 ‖ M ‖} ) + ( 1 - {( 1 - p )}^{N} ) ( 1 + \frac{\sqrt{N}}{\sqrt{2 ‖ Y ‖}} ) ) \qquad [ Equation 8 ]$$

Further, the error due to depolarizing noise experienced in the quantum system can be expressed as an equality given by equation 9, below.

$$\frac{ϵ}{‖ \dot{θ} ‖} = \frac{1 - {( 1 - p )}^{N}}{{( 1 - p )}^{N}} \qquad [ Equation 9 ]$$

With reference again to FIG. 4, FIG. 4 shows an example quantum circuit that can evaluate the elements of the matrix M with error ε occurring after every gate (e.g., see Equation 3).

The circuit in FIG. 4 can be decomposed into three parts. The first part (e.g., upper line) is a single qubit that controls the circuit below. (e.g., an ancilla qubit, which can be in the state |0>+eiθ|1>). The second part (e.g., middle line) and the third part (e.g., lower line) each have the same set of gates and the same number of multiple qubits, and represent the same ansatz circuits. The difference between the second part and the third part at some sites (e.g., k-th and q-th site) arise because of the differentiation with respect to the respective parameter at those sites which is used for computing the matrix element.

For representing the differentiation with respect to the respective parameter, the gate at that site is replaced by an appropriate controlled-unitary followed by appropriate unitary at that site. In addition, ansatz circuits with only single and two-qubit gates are considered. For each application of controlled-Uk (Uq) followed by Sk (Sq) as the k(q)-th gate in the circuit, the error is applied after the combined gates (e.g., Uk and Sk, Uq and Sq). The circuit in FIG. 4 is just an example, and embodiments are not limited thereto.

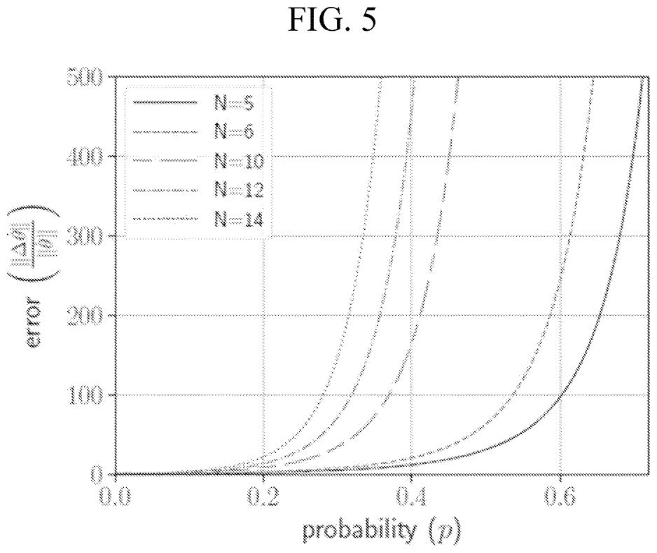

FIG. 5 illustrates a plot of the upper bound on the relative error in the rate of change of the parameters with respect to the probability with which the depolarizing noise occurs for different ansatzes with the same condition number but different number of parameters N (e.g., number of quantum gates for theta rotations), when N=6 and N=14 can be seen as simulating H2 and LiH molecules in the minimum basis set using two layers of the hardware-efficient ansatz, respectively.

As shown in FIG. 5, as the number of parameters N increase, the likelihood of the error increases. Thus, even for relatively shallow quantum circuits, without any noise mitigation, the error due to noise is considerable.

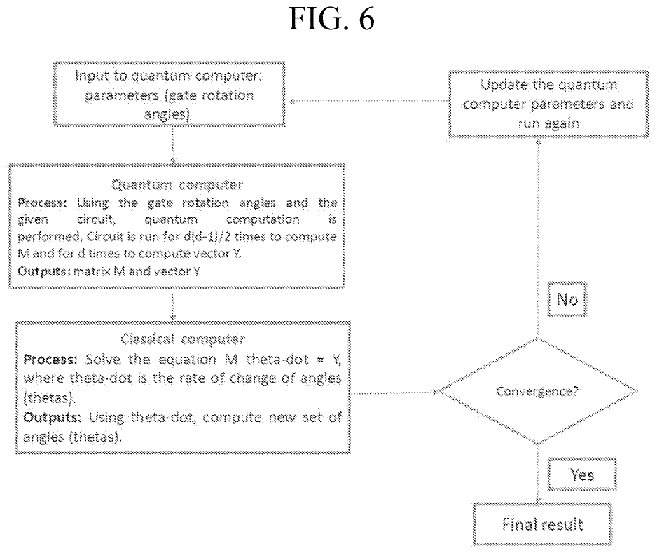

FIG. 6 shows an example flow chart for a method for implementing a quantum imaginary time evolution algorithm without error mitigation, according to an embodiment of the present invention.

For example, the process includes inputting parameters into the quantum computer, such as rotation angles for quantum gates in the quantum circuit. Then the quantum computer uses the gate rotation angles and the given quantum circuit configuration to perform quantum computation. The quantum circuit is run with the provided rotation angles for (d(d−1))/2 times to compute the matrix M of size d×d, and is run with the provided rotation angles for d times to compute vector Y (e.g., matrix Y of size d×1).

Then the process proceeds by the quantum computer outputting the matrix M and the vector Y, which are provided as inputs to the classical computer.

In addition, upon receiving the matrix M and the vector Y, the classical computer solves for θ′, e.g., using Equation 2 above. The solution θ′ can be used by the classical computer to compute a new set of angles (e.g., thetas) that dictate the evolution of variational parameters of the ansatz circuit for the next time step. According to embodiments, the classical computer can use an artificial intelligence (AI) model (e.g., a neural network) to solve for θ′, but embodiments are not limited thereto.

Also, it is determined whether the system converges to a desired state (e.g., the ground state). If convergence is not reached, then the process repeats and the quantum computer is updated with the new set of angles (e.g., thetas) and the quantum circuit is run again.

The process iterates until convergence is reached and the output is a final result.

For example, the final result can be the calculated ground state of the quantum system, which can be useful for a wide range of simulations across various fields, such quantum chemistry, material science, physics, cryptography etc. For instance, calculating the ground state molecules provides insights into their electronic structures, bond energies, and reaction mechanisms, can be used for drug discovery, and developing new materials.

However, the final result may not be reliable due to noise that may be present in the system. Is it important to understand how the error in the final result deviates in the presence of noise, e.g., before any error mitigation techniques are applied to try and reduce the errors.

In order to understand how the errors scale with the probability of noise and how to mitigate the errors, three situations may occur.

A first type of situation that can occur is that the probability of noise is very low (e.g., p<0.0001). In other words, the probability p can be compared to a predefined threshold, before deciding whether to trust the final result of the algorithm without having applied noise mitigation (e.g., FIG. 6). In this situation, implementation of the algorithm (e.g., FIG. 6) can continue without any change. For example, there may be some errors in the final output, but the errors may be very small and sometimes can be ignored.

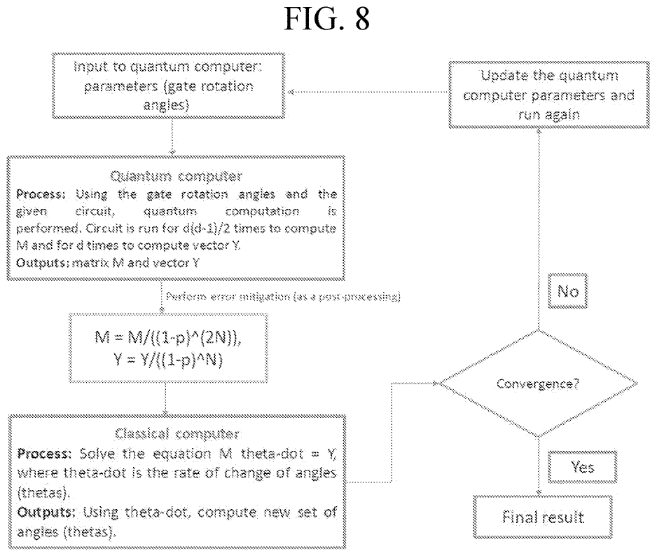

A second type of situation that can occur is that it can be determined that the dominate noise in the system is depolarizing noise. In this situation, the algorithm can be carried out with a post-processing noise mitigation technique, which is explained in more detail below with regards to FIG. 8. For example, the matrix M and vector Y can be divided by (1−p)2N and (1−p)N, respectively. This technique can mainly reduce the effect of the dominant depolarizing noise.

A third type of situation that can occur is that not much may be known about the general noise. In this situation, the elements of the matrix M with error and the elements of vector Y with error calculated with using the noisy quantum computer can be used to make comparisons with the ideal matrix M and the ideal vector Y, in order to allow a user to device whether to rely on the quantum computer or not.

For example, if the difference between matrix M with error and the ideal matrix M is greater than a first predetermined value, and/or if the difference between vector Y with error and the ideal vector Y is greater than a second predetermined value, then a user can avoid using the quantum circuit and/or avoid trying to apply error mitigation with the quantum computer.

The application of error mitigation schemes can consume a lot of time and resources, such as when the quantum circuit has a large size, the efficiency of the QITE algorithm can be canceled or negated due to the application of error mitigation protocols. Thus, it can be very useful for a user to know ahead of time, if such techniques would even be worth the trouble for a given quantum circuit. In this situation, the computation of the elements of the matrix M with error and the elements of vector Y with error can be used to make such a determination.

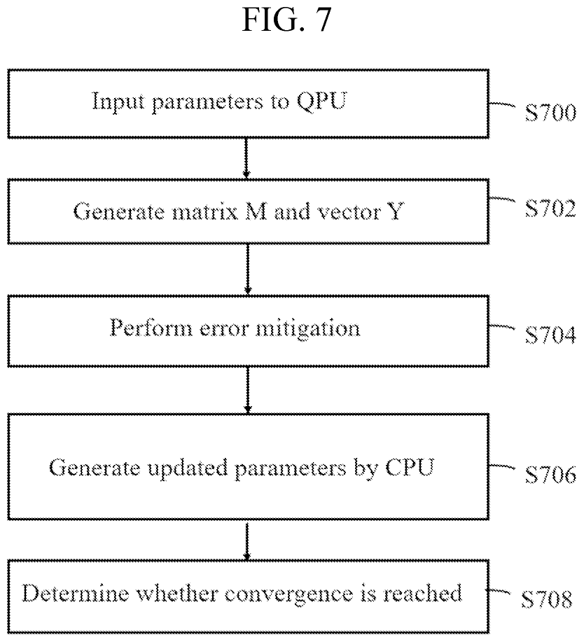

FIG. 7 shows an example flow chart of a method of controlling a quantum computing device according to an embodiment. For example, the quantum computing device can be configured with a method that includes inputting input parameters to a quantum processor, the quantum processor including a plurality of qubits (e.g., S700), and running, via the quantum processor, a quantum circuit based on the input parameters to generate first element values for a state evolution matrix (e.g., matrix M) and second element values for a Hamiltonian based vector (e.g., vector Y), the quantum circuit including a plurality of quantum gates (e.g., S702).

Also, the state evolution matrix (e.g., matrix M) can be referred to as a parameter-parameter similarity matrix whose (i,j)-th element contains information about the similarity between the rate of change of wavefunction with respect to the i-th and the j-th parameter.

Further, the Hamiltonian based vector (e.g., vector Y) can be referred to as a parameter-Hamiltonian similarity vector whose i-th element contains information about the similarity between the rate of change of wavefunction with respect to the i-th parameter and wavefunction as evolved under the Hamiltonian H.

In addition, if the dominant noise in quantum computer is depolarizing, then with reference again to FIG. 7, the method can further include performing, via a processor that is transistor based (e.g., CPU), an error mitigation operation by dividing the state evolution matrix based on a first mitigation component to generate a compensated state evolution matrix and dividing the Hamiltonian based vector based on a second mitigation component to generate a compensated Hamiltonian based vector (e.g., S704).

For example, the error mitigation operation here refers to dividing the matrix M by the factor (1−p)2N and dividing the vector Y by the factor (1−p)N, where p is the probability of mixing white noise and N is the number of parameters for the quantum circuit.

In contrast to other error mitigation techniques which can be very time consuming and resource intensive, the error mitigation operation as presented above, which is just a division operation provides an elegant solution that can adequately address depolarizing noise in a matter that drastically reduces processing times and conserves computing resources.

For example, the division operations used for the error mitigation operation can reduce processing time and save resources because they can be based on taking advantage of the symmetry features that is present in Equation 9, above. This can be used to address a specific type of noise, e.g., depolarizing noise, and depolarizing noise is often a major source of errors in NISQ computers. Thus, this elegant error mitigation operation can be especially useful for NISQ computers, particularly when dealing with evolving the quantum sate in QITE.

Also, according to embodiments, the input parameter p can be input by a user during an initialization step, calculated based on parameters of the quantum circuit, or a predetermined value stored in memory.

According to various embodiments, the error mitigation operation can be carried out by an error mitigation module that is integrated into quantum computer, or integrated into the classical computer (e.g., CPU), but embodiments are not limited thereto. For example, according to an embodiment, the error mitigation module can be executed by a separate device that is connected between the quantum computer (e.g., QPU) and the classical computer (e.g., CPU).

Further, the method can include solving a cost function based on the compensated state evolution matrix and the compensated Hamiltonian based vector, via the processor, to generate updated parameters (e.g., S706). For example, the cost function can be based solving for θ′ based on Equation 2, above.

In addition, the method can further include, in response to reaching a state of convergence, outputting, via the processor, a final result, and in response to convergence not being reached, inputting the updated parameters to the quantum processor and running the quantum circuit again based on the updated parameters (e.g., S708). For example, the process can be repeated until convergence is reached and the final result is output. Also, the final result can correspond to a ground state of the quantum system.

In more detail, FIG. 8 shows an example flow chart for a method for implementing a quantum imaginary time evolution algorithm with noise mitigation when the dominant noise is the depolarizing noise, according to another embodiment of the present invention.

For example, the process includes inputting parameters into the quantum computer, such as rotation angles for quantum gates in the quantum circuit. Then the quantum computer uses the gate rotation angles and the given quantum circuit configuration to perform quantum computation. The quantum circuit is run with the provided rotation angles for (d(d−1))/2 times to compute the matrix M of size d×d, and is run with the provided rotation angles for d times to compute vector Y (e.g., matrix Y of size d×1).

Then the process proceeds by the quantum computer outputting the (erroneous) matrix M and the vector Y. Once the matrix M and the vector Y are computed, an error mitigation operation can be performed. For example, the matrix M can be divided by (1−p)2N and the vector Y can be divided by (1−p)N, where p is the probability of mixing white noise and N is the number of parameters for the quantum circuit.

In addition, upon receiving the matrix M and the vector Y with error mitigation applied, the classical computer solves for θ′, e.g., using Equation 2 above. The solution θ′ can be used by the classical computer to compute a new set of angles (e.g., thetas) that dictate the evolution of variational parameters of the ansatz circuit for the next time step. According to embodiments, the classical computer can use an artificial intelligence (AI) model (e.g., a neural network) to solve for θ′, but embodiments are not limited thereto.

Also, it is determined whether the system converges to a desired state (e.g., the ground state). If convergence is not reached, then the process repeats and the quantum computer is updated with the new set of angles (e.g., thetas) and the quantum circuit is run again.

The process iterates until convergence is reached and the output is a final result.

According to one or more embodiments of the present disclosure, the quantum computing device can solve one or more technological problems in the existing technology, such as evaluating noise in a quantum circuit, performing a noise mitigation operation to reduce noise in the system, and more accurately determining the ground state of a quantum system.

In addition, the quantum computing device can more accurately and more reliably determine the ground state of a quantum system, which can be used for various applications, such as factoring, solving linear systems, quantum simulations, decryption, cryptography and quantum chemistry/material discovery.

According to one or more embodiments, the quantum computing device can adequately address depolarizing noise in a matter using an elegant solution that drastically reduces processing times and conserves computing resources.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for mitigating noise in a quantum computing device, the method comprising:
inputting input parameters to a quantum processor, the quantum processor including a plurality of qubits;
running, via the quantum processor, a quantum circuit based on the input parameters to generate first element values for a state evolution matrix and second element values for a Hamiltonian based vector, the quantum circuit including a plurality of quantum gates;
performing, via a processor that is transistor based, an error mitigation operation by dividing the state evolution matrix based on a first mitigation component to generate a compensated state evolution matrix and dividing the Hamiltonian based vector based on a second mitigation component to generate a compensated Hamiltonian based vector;
solving a cost function based on the compensated state evolution matrix and the compensated Hamiltonian based vector, via the processor, to generate updated parameters;
in response to reaching a state of convergence, outputting, via the processor, a final result; and
in response to convergence not being reached, inputting the updated parameters to the quantum processor and running the quantum circuit again based on the updated parameters.

2. The method of claim 1, wherein the quantum circuit is based on a quantum imaginary time evolution (QITE) algorithm.

3. The method of claim 1, wherein the dividing the state evolution matrix includes dividing each of the first elements by the first mitigation component, and
wherein the dividing the Hamiltonian based vector includes dividing each of the second elements by the second mitigation component.

4. The method of claim 3, wherein the input parameters include a probability value corresponding to a probability of mixing white noise,
wherein the first mitigation component is defined by a first equation:
(1−p)^{2N},
and
wherein the second mitigation component is defined by a second equation:
(1−p)^{N},
where p is the probability value, and N is a number of parameters of the quantum circuit.

5. The method of claim 1, further comprising:
running, via the quantum processor, the quantum circuit for a first number of times to generate the state evolution matrix; and
running, via the quantum processor, the quantum circuit for a second number of times to generate the Hamiltonian based vector,
wherein the first number of times is less than the second number of times.

6. The method of claim 5, wherein the first number of times is (d(d−1))/2, and the second number of times is d, where d is a dimension of the state evolution matrix.

7. The method of claim 1, wherein the cost function is based on solving for θ′ in equation:
$${\sum }_{q} {M}_{k , q} {\dot{θ}}_{q} = {Y}_{k} ,$$
where M is the state evolution matrix, θ′ is a vector including elements each corresponding to a change of a parameter for a given time step, and Y is the Hamiltonian based vector, and k and q are indexing values.

8. The method of claim 1, wherein the error mitigation operation mitigates errors due to a depolarizing quantum noise channel.

9. The method of claim 1, wherein the updated parameters include rotation angle values for adjusting the plurality of quantum gates in the quantum circuit.

10. The method of claim 1, further comprising:
determining a ground state of the quantum circuit based on the final result.

11. A quantum computing device, comprising:
a memory configured to store parameter information;
a quantum processor including a plurality of qubits, configured to:
receive input parameters,
run a quantum circuit based on the input parameters to generate first element values for a state evolution matrix and second element values for a Hamiltonian based vector, the quantum circuit including a plurality of quantum gates, and
output the state evolution matrix and the Hamiltonian based vector; and
a processor that is transistor based, configured to:
receive the state evolution matrix and the Hamiltonian based vector from the quantum processor,
perform an error mitigation operation by dividing the state evolution matrix based on a first mitigation component to generate a compensated state evolution matrix and dividing the Hamiltonian based vector based on a second mitigation component to generate a compensated Hamiltonian based vector,
solve a cost function based on the compensated state evolution matrix and the compensated Hamiltonian based vector to generate updated parameters,
in response to reaching a state of convergence, output a final result, and
in response to convergence not being reached, input the updated parameters to the quantum processor for running the quantum circuit again based on the updated parameters.

12. The quantum computing device of claim 11, wherein the quantum circuit is based on a quantum imaginary time evolution (QITE) algorithm.

13. The quantum computing device of claim 11, wherein the processor is further configured to:
divide each of the first elements by the first mitigation component to generate the compensated state evolution matrix, and
divide each of the second elements by the second mitigation component to generate the compensated Hamiltonian based vector.

14. The quantum computing device of claim 13, wherein the input parameters include a probability value corresponding to a probability of mixing white noise,
wherein the first mitigation component is defined by a first equation:
(1−p)^{2N},
and
wherein the second mitigation component is defined by a second equation:
(1−p)^{N},
where p is the probability value, and N is a number of parameters of the quantum circuit.

15. The quantum computing device of claim 11, wherein the quantum processor is further configured to:
run the quantum circuit for a first number of times to generate the state evolution matrix, and
run the quantum circuit for a second number of times to generate the Hamiltonian based vector,
wherein the first number of times is less than the second number of times.

16. The quantum computing device of claim 15, wherein the first number of times is (d(d−1))/2, and the second number of times is d, where d is a dimension of the state evolution matrix.

17. The quantum computing device of claim 11, wherein the cost function is based on solving for θ′ in equation:
$${\sum }_{q} {M}_{k , q} {\dot{θ}}_{q} = {Y}_{k} ,$$
where M is the state evolution matrix, θ′ is a vector including elements each corresponding to a change of a parameter for a given time step, and Y is the Hamiltonian based vector, and k and q are indexing values.

18. The quantum computing device of claim 11, wherein the error mitigation operation mitigates errors due to a depolarizing quantum noise channel.

19. The quantum computing device of claim 11, wherein the updated parameters include rotation angle values for adjusting the plurality of quantum gates in the quantum circuit.

20. The quantum computing device of claim 11, wherein the processor is further configured to:
determine a ground state of the quantum circuit based on the final result.
